(19) United States
(12) Patent Application Publication
(10) Pub. No.: US 2016/0300502 A1
(43) Pub. Date: Oct. 13, 2016

(54) GOVERNING ACCESS TO SOFTWARE BASED ON COMPLETION OF EDUCATIONAL TASKS

(71) Applicants: Michael DUDEK, Chicago, IL (US); Shaun MOORE, Lake Forest, IL (US)

(72) Inventors: Michael DUDEK, Chicago, IL (US); Shaun MOORE, Lake Forest, IL (US)

(73) Assignee: Michael DUDEK, Chicago, IL (US)

(21) Appl. No.: 15/052,130

(22) Filed: Feb. 24, 2016

Related U.S. Application Data
(60) Provisional application No. 62/121,466, filed on Feb. 26, 2015.

(51) Int. Cl. G09B 7/00; G09B 19/02; G09B 19/00; G09B 17/00

(52) U.S. Cl. CPC G09B 7/00; G09B 17/00; G09B 19/025; G09B 19/00

(57) ABSTRACT

Techniques of controlling access to one or more functions on a computing device. Aspects of the technique include accepting designation of the one or more functions and requiring completion of one or more educational tasks to permit access to the one or more functions. The functions may include playing a game, accessing social media, or the like. Certain functions, such as making an emergency (e.g., 911) call, may be excluded from being affected by the technique. Also, systems including at least one tangible computing element that perform such techniques.

### CROSS-REFERENCE TO RELATED APPLICATION

This application claims the benefit of U.S. Provisional Application No. 62/121,466 titled “GOVERNING ACCESS TO SOFTWARE BASED ON COMPLETION OF EDUCATIONAL TASKS” and filed 26 Feb. 2015 in the name of the same inventors as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER FUNCTION LISTING COMPACT DISK APPENDIX

Not Applicable

### BACKGROUND

The present disclosure generally relates to governing access to software on a computing device through the completion of educational material.

### SUMMARY

Aspects of the subject technology include techniques of controlling access to one or more functions on a computing device. Aspects of the technique include accepting designation of the one or more functions and requiring completion of one or more educational tasks to permit access to the one or more functions. Examples of the functions may include playing a game, accessing social media, or the like. Certain functions, such as making an emergency (e.g., 911) call, may be excluded from being affected by the technique.

The subject technology also includes systems configured to perform the above techniques.

This brief summary has been provided so that the nature of the invention may be understood quickly. Additional steps and/or different steps than those set forth in this summary may be used. A more complete understanding of the invention may be obtained by reference to the following description in connection with the attached drawings.

### BRIEF DESCRIPTION OF THE DRAWINGS

FIG. 1 illustrates an example of a welcome screen according to aspects of the subject technology.

FIG. 2 illustrates an example of a profile set-up screen according to aspects of the subject technology.

FIG. 3 illustrates another example of a profile set-up screen according to aspects of the subject technology.

FIG. 4 illustrates a continuation of the example illustrated in FIG. 3.

FIG. 5 illustrates yet another example of a profile set-sup screen according to aspects of the subject technology.

FIG. 6 illustrates an example of a profile selection screen according to aspects of the subject technology.

FIG. 7 illustrates an example of a screen that can be used to access parental diagnostics according to aspects of the subject technology.

FIG. 8 illustrates a block diagram of a system that may be used to implement aspects of the subject technology.

### DETAILED DESCRIPTION

U.S. Provisional Application No. 62/121,466 titled “GOVERNING ACCESS TO SOFTWARE BASED ON COMPLETION OF EDUCATIONAL TASKS” and filed 26 Feb. 2015 in the name of the same inventors as this non-provisional application is hereby incorporated by reference as if fully set forth herein.

Briefly, techniques according to aspects of the subject technology include governing access to functionality (e.g., software) on or through a computing device based on completion of one or more educational tasks.

The computing functionalities may run on one computing device or be divided amongst plural computing devices. The computing device(s) may be any computing/gaming/learning platform(s) and may be situated in any setting, for example but not limited to the home, an educational environment (e.g., school), social media, and the like. Examples of the educational task(s) include but are not limited to answering one or more math, reading, science, or other educational problems or questions.

In some aspects, once a function is installed on a computing device (e.g., application or other functionality on a mobile computing device), the function may display a set of other functions (e.g., applications or other functionality) accessible on or by the computing device or one or more other computing devices. The displayed other functions may be pre-populated, selected by a user, or defined in any other manner. A user may then select that access to one or more of the other functions is controlled by aspects of the subject technology. For example, a parent may download an application that permits control of access to functionality by his or her children on their computing device(s). Examples of the functionality to which access is controlled may include playing a game, accessing social media, device features (e.g., internet access, camera operation, texting, etc.), or the like.

Some functions may be excluded from such control. Examples with respect to a mobile computing device include but are not limited to an emergency (e.g., 911) call, calling “home” (e.g., parents), and/or otherwise operating as a basic communication device.

Access of functionality granted upon completion of the educational task(s) may be limited. For example, a certain number of game plays, page views, posts, texts (e.g., number of texts or characters), pictures taken, time used, or the like may be permitted before completion of another educational task is required for further access.

Multiple profiles may be designated for controlling access to functionality according to aspects of the subject technology. The profiles may be designated on one computing device to control such access. For example, a parent may use an application on his or her mobile computing device (e.g., mobile phone) to control access by his or her children to applications on their mobile computing devices (e.g., mobile phones). Likewise, control of access to functionality may be shared, for example between parents, permitted education professionals such as teachers and school administrators, grandparents, other relatives, guardians, and the like.

Access to profiles for designating control of functionality according to aspects of the subject technology may be protected via a passcode, for example a four digit number. The passcode may be shared to facilitate sharing of such control with others, as described above.

A person with access to profiles may set and/or change the nature of the educational task(s) according to aspects of the subject technology. For example, the person may designate grade level(s), time(s) for completion of task(s), time to be spent, and/or completion rate(s) that must be met to permit access to the other functionality (e.g., games, social media, and the like.)

In some aspects, diagnostics may be provided for monitoring completion of the educational task(s). Such access may also be protected by a passcode. The diagnostics may be transmitted to and accessible through a website.

Machine learning and/or automation may be applied to the subject technology. For example, machine learning and/or automation may be used to adjust a profile (i.e., make academic choices). The adjustment may be based on performance of educational task(s) in order to increase or decrease difficulty based on past performance, based on or in order to meet a curriculum, or the like. Profiles may also be adjusted manually according to aspects of the technology.

Some computing device operating systems do not allow direct control of access to applications by another application. For example, iOS generally does not permit one application to control access to another application. According to aspects of the subject technology, the applications themselves may integrate such control. For example, a game may integrate with an application according to the subject technology such that play of the game is dependent upon completion of the educational task(s). The game may be sold as a “premium” version.

In more detail, aspects of the subject technology include a system that has at least one computing device including one or more tangible computing elements. The system performs steps including accepting designation of one or more functions and requiring completion of one or more educational tasks to permit access to the one or more functions. The functions may include playing a game, accessing social media, or the like. Designation of parameters for the one or more educational tasks may be accepted, for example grade levels, a required completion time, or the like.

The functions may be provided by someone other than the provider of the system and may incorporate elements that facilitate the step of requiring completion of the one or more educational tasks. Certain functions may be excluded from the control by the subject technology, for example making an emergency (e.g., 911) call.

Examples of screen images for one possible embodiment of the subject technology accompany this document. The subject technology is not limited to these examples.

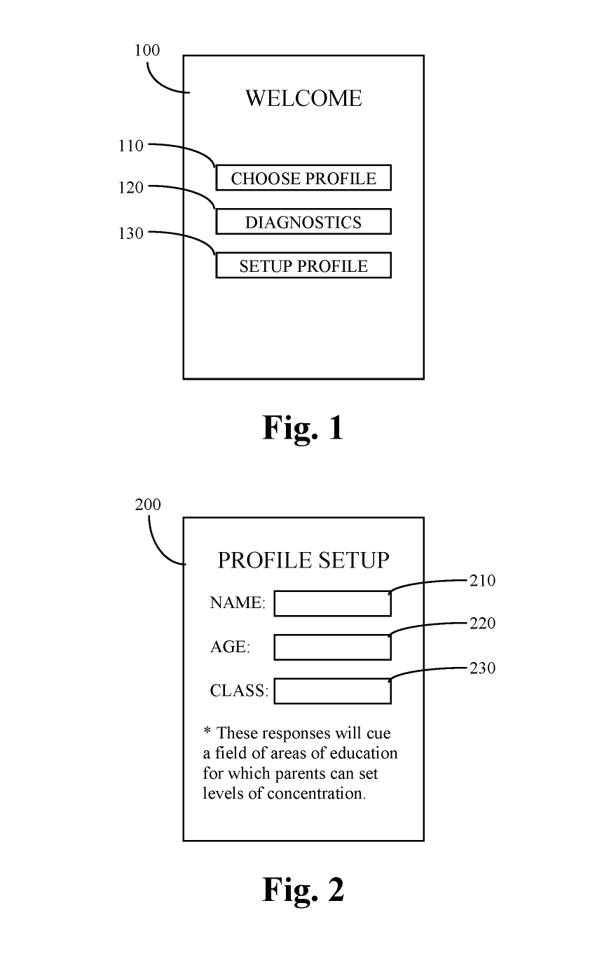

FIG. 1 illustrates an example of a welcome screen according to aspects of the subject technology. Screen 100 includes three buttons: Choose Profile button 110, Diagnostics Button 120, and Setup Profile Button 130. Choose Profile button 110 allows a user to select an existing profile associated with their account. Diagnostics Button 120 allows the user to access diagnostics for those profiles, for example as described above. Setup Profile button 130 allows the user to set up a new profile.

FIG. 2 illustrates an example of a profile set-up screen according to aspects of the subject technology. Screen 200 includes fields for a person's name 210, age 220, and class 230. Additional fields such as specification of a mobile phone number may also be included. Linkage between the person using screen 200 and the person specified on the screen preferable is controlled by security measures, for example a verified linkage between the people.

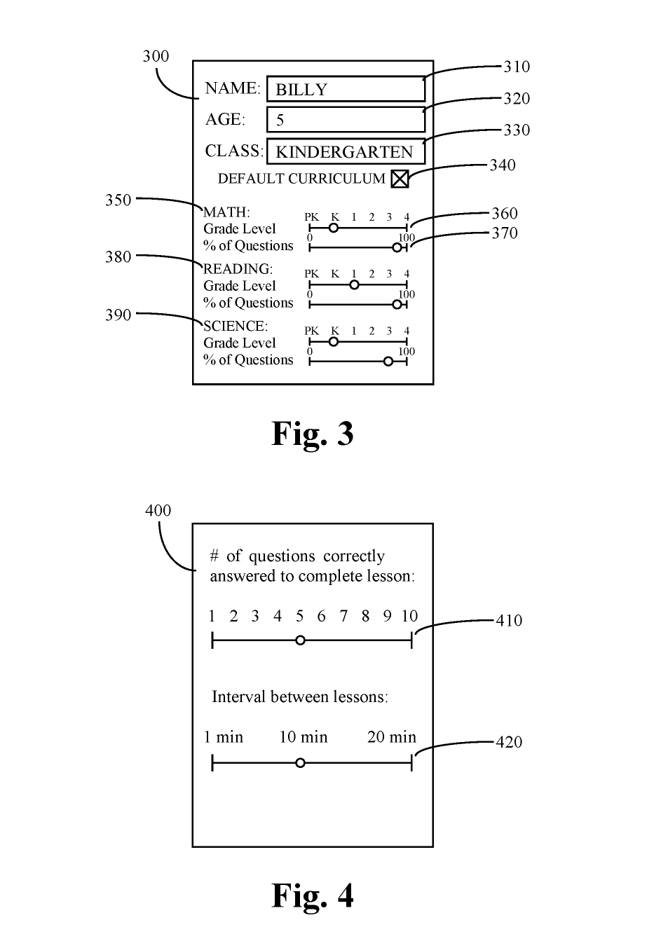

FIG. 3 illustrates another example of a profile set-up screen according to aspects of the subject technology. On screen 300, name 310, age 320, and class 330 have been specified. A default (e.g., math, reading, and science) has been selected via box 340. In some aspects, unchecking box 340 leads to a screen (not shown) for choosing another curriculum, for example including math, reading, science, art, history, and/or any other topic.

Parameters for meeting math 350, reading 360, and science 370 educational tasks in order to be granted to other functionality (e.g., a game, social media, or the like) have been specified in FIG. 3. In the example illustrated by FIG. 3, the parameters have been specified using slide bars 360 and 370. FIG. 4 illustrates a continuation of the example illustrated in FIG. 3. Screen 400 includes further slide bars 410 and 420 for specifying a “# of questions answered to complete lesson” and an “interval between lessons.” The latter parameter may be provided to prevent a child from simply repeating a lesson over and over again without truly learning.

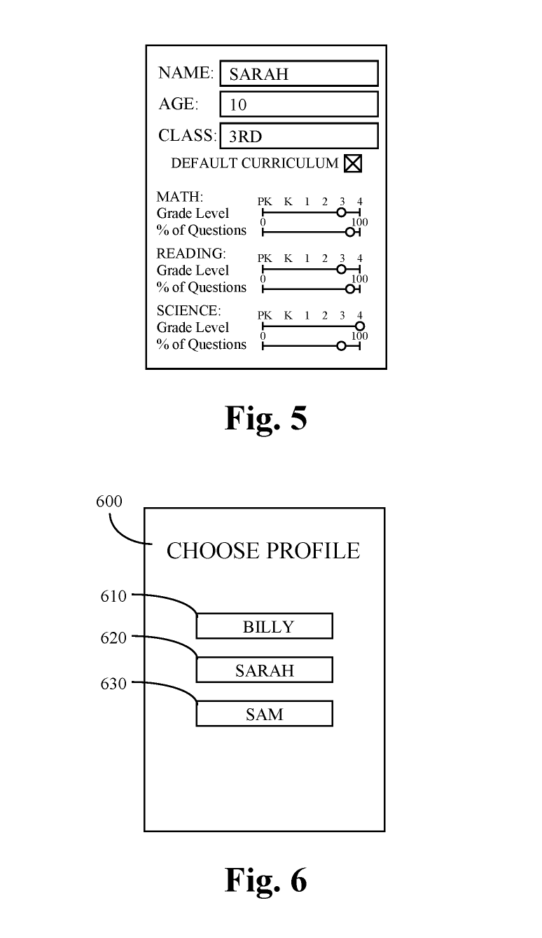

FIG. 5 illustrates yet another example of a profile set-sup screen according to aspects of the subject technology. This figure shows similar fields as FIG. 3 with different values supplied.

FIG. 6 illustrates an example of a profile selection screen according to aspects of the subject technology. Screen 600 shows three profiles 610, 620, and 630. Clicking on, tapping, or otherwise triggering these profiles may permit a user to access screens such as those shown in FIGS. 3 to 5.

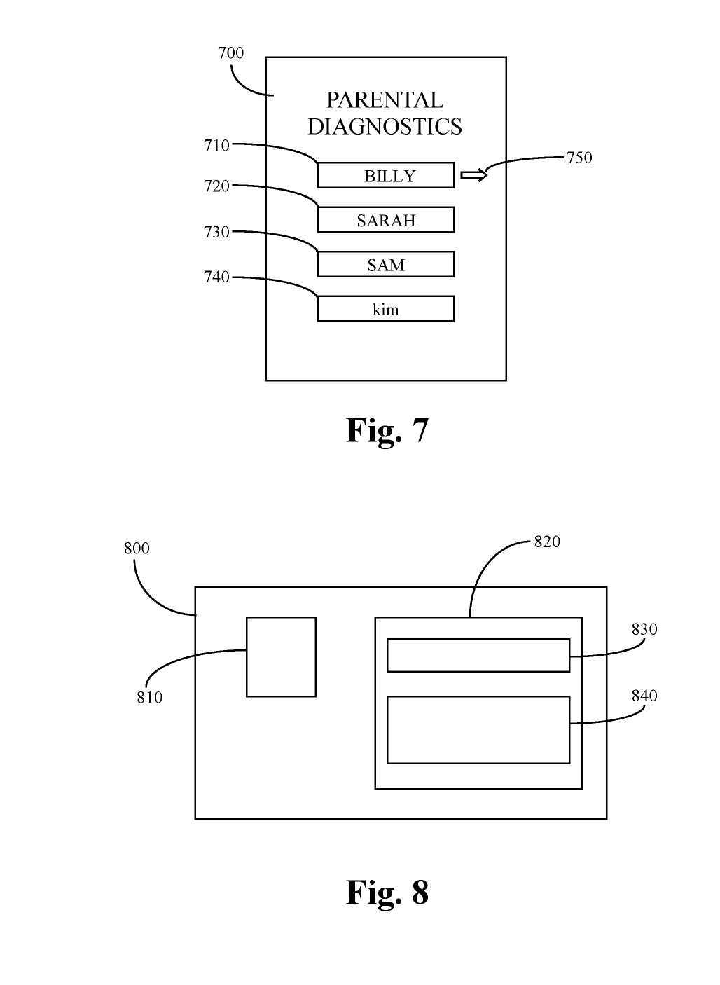

FIG. 7 illustrates an example of a screen that can be used to access parental diagnostics according to aspects of the subject technology. Four names 710, 720, 730, and 740 are shown in FIG. 7. Clicking on, tapping, or otherwise triggering these names may permit a user to see diagnostics about that person. As mentioned above, such diagnostics may be provided for monitoring completion of the educational task(s).

Various privacy controls may be incorporated into the subject technology. For example, various authentication methods may be used to ensure that the user has a right to access private information about the people and/or profiles shown in various ones of the figures.

FIG. 8 illustrates a block diagram of a system that may be used to implement aspects of the subject technology. Computing device 800 includes at least one tangible computing element 810. Computing device 800 also preferably includes storage 820 for instructions 830 to perform processes such as those described above and also instructions 840 for other software. Alternatively, the instructions 830 and/or 840 may be for accessing such instructions on another computing device. Computing device 800 may perform the processes and/or other software alone or in combination with one or more other computing devices, for example a web or other type of server. Other elements, for example input/output and data communication elements, preferably also are included.

Examples of computing device 800 include but are not limited to a laptop computer, a desktop computer, a mobile computing device such as a smart phone or tablet computer, a server, a smart television, a game counsel, a part of a cloud computing system, or any other form of computing device.

Aspects of the subject technology may be spread across multiple computing devices. For example, some processes may be performed by a server while others are performed on a mobile computing device. For another example, multiple computing devices may be able to access one child's profile. For yet another example, the educational tasks may be accessible from multiple computing devices. One instance of this example would be for a child to start an educational task on his or her mobile computing device, stop working on the educational tasks on that device, and then complete the educational tasks on a game counsel.

The invention is in no way limited to the specifics of any particular embodiments and examples disclosed herein. For example, the terms “aspect,” “example,” “preferably,” “alternatively” and the like denote features that may be preferable but not essential to include in some embodiments of the invention. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope and spirit of the invention, and these variations would become clear to those skilled in the art after perusal of this application.

What is claimed is:

1. A system comprising at least one computing device including one or more tangible computing elements that perform steps comprising:
accepting designation of one or more functions; and
requiring completion of one or more educational tasks to permit access to the one or more functions.

2. A system as in claim 1, wherein the functions include playing a game.

3. A system as in claim 1, wherein the functions include accessing social media.

4. A system as in claim 1, wherein the functions are provided by someone other than the provider of the system and incorporate elements that facilitate the step of requiring completion of the one or more educational tasks.

5. A system as in claim 1, wherein the steps further comprise excluding certain functions from the step of accepting.

6. A system as in claim 5, wherein the certain functions include making an emergency call.

7. A system as in claim 1, wherein the steps further comprise accepting designation of parameters for the one or more educational tasks.

8. A system as in claim 7, wherein the parameters comprise grade levels for the educational task.

9. A system as in claim 7, wherein the parameters comprise a required completion time for the educational task.

10. A system as in claim 1, wherein the steps further comprise providing diagnostics regarding completion of the educational tasks.

11. A method of controlling access to one or more functions on a computing device, comprising:
accepting designation of the one or more functions; and
requiring completion of one or more educational tasks to permit access to the one or more functions.

12. A method as in claim 11, wherein the functions include playing a game.

13. A method as in claim 11, wherein the functions include accessing social media.

14. A method as in claim 11, wherein the functions are provided by someone other than the provider of the method and incorporate elements that facilitate the step of requiring completion of the one or more educational tasks.

15. A method as in claim 11, further comprising excluding certain functions from the step of accepting.

16. A method as in claim 15, wherein the certain functions include making an emergency call.

17. A method as in claim 11, further comprising accepting designation of parameters for the one or more educational tasks.

18. A method as in claim 17, wherein the parameters comprise grade levels for the educational tasks.

19. A method as in claim 17, wherein the parameters comprise a required completion time for the educational task.

20. A method as in claim 11, wherein the steps further comprise providing diagnostics regarding completion of the educational tasks.
